(19) United States
(12) Patent Application Publication
(10) Pub. No.: US 2006/0012795 A1
(43) Pub. Date: Jan. 19, 2006

(54) Method of determining surface plasmon resonances at two-dimensional measurement surfaces

(75) Inventors: Kay Niemax, Schwerte (DE); Alexander Zybine, Dortmund (DE)

Correspondence Address: WILLIAM COLLARD;COLLARD & ROE, P.C., 1077 NORTHERN BOULEVARD, ROSLYN, NY, 11576, US

(73) Assignee: Gesellschaft zur Förderung der Spektrochemie und angewandten Spektroskopie e.V.

(21) Appl. No.: 11/177,981

(22) Filed: Jul. 7, 2005

(30) Foreign Application Priority Data
Jul. 13, 2004 (DE) 10 2004 033 869.8

(51) Int. Cl. G01N 21/55

(52) U.S. Cl. 356/445

(57) ABSTRACT

A method of determining surface plasmon resonances at two-dimensional measurement surfaces, in which the measurement surface which is formed by a thin metal film and which is brought into contact with a specimen to be measured is illuminated and the intensity distribution in the reflected beam is measured is to be further developed in such a way that it is substantially more sensitive (in respect of measurement) and is more resistant to interference. That is achieved in that the measurement surface is illuminated with two collimated monochromatic laser beams of differing wavelengths which are spatially combined to form an overall beam and the difference in the intensities reflected at the two wavelengths is measured to characterise plasma resonance.

The invention concerns a method of determining surface plasmon resonances at two-dimensional measurement surfaces, in which the measurement surface which is formed by a thin metal film and which is brought into contact with a specimen to be measured is illuminated and the intensity distribution in the reflected beam is measured.

Surface plasmon resonance is a current method which can be used for the simultaneous characterisation of analytes in two-dimensional structures. Surface plasmon resonance is the result of the interaction between electromagnetic waves and the free electron gas of a conducting surface. Surface plasmon resonance is based on total internal reflection at the interface between a dielectric and a metal layer, that is to say between two media whose dielectric constants involve different signs. A greatly attenuated electromagnetic surface wave progresses along the metal layer. Within the volume of the attenuated electromagnetic wave, changes in concentration, for example of biomolecules, are detected in the form of changes in the refractive index at the surface. At the same time that leads to a change in the resonance condition of the electromagnetic light wave reflected at the metal layer.

Depending on the respective nature of detection, it is possible to detect either the change in the reflection angle at which the intensity of the reflected light is a minimum (resonance) or the change in the resonance wavelength with a fixed angle of incidence. The first-mentioned detection mode is usually implemented in what is known as the Kretschmann arrangement in which a very thin layer of gold or the like is vapour deposited on the base surface of a prism, monochromatic light is radiated at different angles of incidence on to that gold layer and the reflected intensity is detected as a function of the angle.

In that case the angle of incidence is so selected that the wavelength of the radiation is set to the steep flank of the plasmon resonance. Each change in refractive index in the medium adjoining the irradiated surface results in a shift in resonance and consequently a change in intensity of the reflected beam which can be measured for example by means of a CCD camera or a surface arrangement of photodetectors simultaneously and in location-resolved fashion. That method is admittedly already known as from the beginning of the Seventies of the last century, but hitherto it has not enjoyed any commercial implementation worth mentioning, which is primarily to be attributed to the fact that it is susceptible to disturbances of a widely varying nature.

Two-dimensional plasmon resonance imaging is nonetheless gaining increasing significance in recent times. It permits simultaneous online investigations of a plurality of adsorption processes at a surface under identical conditions. Thus for example biological processes such as DNA/DNA, DNA-protein and protein/protein reactions are investigated therewith.

There is an imported, well-established device for plasma resonance on the market from BIACORE. In that case the surface is illuminated with a convergent monochromatic beam, the distribution of intensity in the divergent reflected beam characterising plasmon resonance. The different regions of the irradiated surface are sequentially surveyed in that case.

The methods which are suitable for 2-D measurements of surface plasmon resonance normally use illumination of the surface with an expanded parallel monochromatic beam. In that procedure distribution of intensity is measured by means of a CCD camera. The angle dependency of the reflection is recorded with mechanical rotation of the surface (of the prism).

In a further method which does not require mechanical rotation during the measurement procedure, the surface is also illuminated with an expanded parallel monochromatic beam. Here the angle of incidence is so set that the wavelength is on the steep flank of plasma resonance. Any change in refractive index at the illuminated surface results in shifts in the resonance phenomena and changes in intensity in the reflected beam, which can be measured by means of a CCD camera. It will be noted however that that method is susceptible to a non-specific reduction in intensity, for example due to absorption of the radiation by a changing medium at the surfaces. That method has hitherto not been commercially carried into effect.

The problem of the present invention is to further develop a method of that kind in such a way that it is substantially more sensitive (in respect of measurement) and is more resistant to disturbances.

In accordance with the invention, in a method of the kind set forth in the opening part of this specification, that problem is solved in that the measurement surface is illuminated with two collimated monochromatic laser beams of differing wavelengths which are spatially combined to form an overall beam and the difference in the intensities reflected at the two wavelengths is measured to characterise plasma resonance.

In accordance with the invention therefore the surface is irradiated with two monochromatic beams which are spatially combined in one beam. The difference in the reflected intensities of the two wavelengths is measured. If the density of the medium at the surface changes, that involves a shift in the surface plasmon resonance curve. In that case the reflected intensity for the one wavelength increases while it falls for the other, and a difference signal is thus produced. The difference can be measured in location-resolved fashion for example by means of a triggerable CCD camera or a matrix comprising a plurality of photoelectric diodes. It is thus possible to implement simultaneous measurement with a plurality of points, sequential measurements or mechanical rotation of the surface of the prism are not required.

The method can be used for the simultaneous characterisation of physical, chemical and biological properties and processes. It makes it possible to track processes which change in respect of time, with a high level of detection power and robustness, as are of interest for example in relation to DNA/DNA, DNA/protein, protein/protein binding reactions, or for the characterisation of immunoassay reactions in drug development in pharmacology.

In a particularly preferred configuration it is provided that the wavelengths of the two laser beams are so set to the oppositely disposed flanks of the resonance curve that the reflection is at least approximately equal for both wavelengths. It is possible in that way to achieve a particularly high level of measuring accuracy.

Measurement of the difference in intensities is preferably implemented by means of a triggerable CCD camera or a matrix of a plurality of photoelectric diodes in a plurality of measurement points of the measurement surface.

In a particularly preferred feature it is further provided that at least one region of the overall measurement surface is used as a reference surface for continuous standardisation of the measurement operation. In such location-resolved measurement procedures therefore it is possible to use one or more regions of the overall surface as reference surfaces. In that way it is possible to reduce the influence of temperature fluctuations, changes in refractive index and non-specific change in reflected intensity, for example due to absorption, during the measurement procedure, by standardisation.

The invention is described in greater detail by way of example hereinafter with reference to the drawing in which:

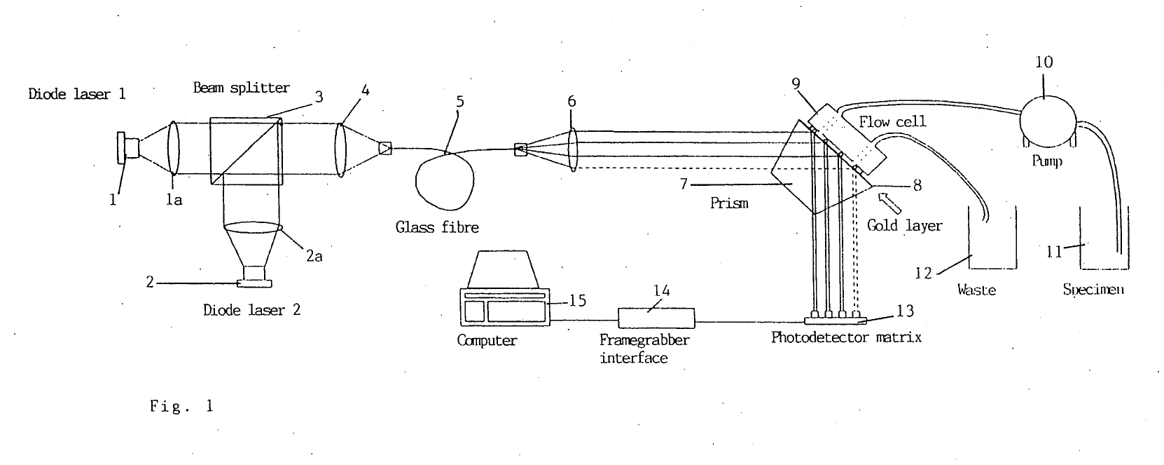

FIG. 1 is a diagrammatic view of an apparatus for carrying out the method according to the invention, and

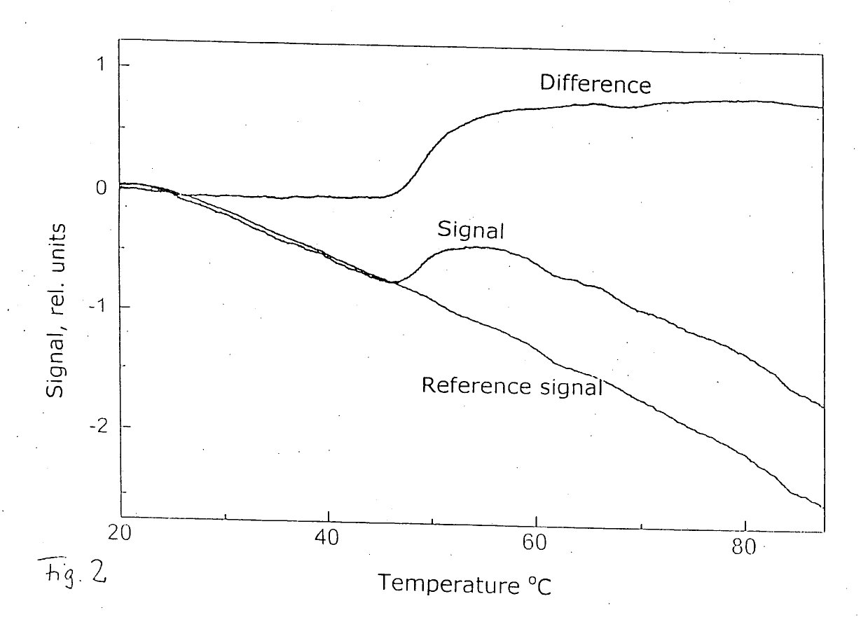

FIG. 2 is a measurement graph plotting the measured intensity signals of reflected beams in relation to temperature.

An apparatus for determining surface plasmon resonances at two-dimensional measurement surfaces has a first diode laser 1 with lens 1a and a second diode laser 2 which is arranged at a right angle relative thereto, with a lens 2a. The two diode lasers 1, 2 produce collimated monochromatic laser beams of different wavelengths, which are spatially combined by way of a beam splitter 3 to afford an overall beam which is introduced focused by way of a lens 4 into a glass fibre cable 5. That spatially combined overall beam is diverted by way of a further lens 6 on to a prism 7 in a Kretschmann arrangement. To form the measurement surface that prism 7 is provided with a metal layer 8 (for example gold), at the rear side of which, in the illustrated embodiment, there is arranged a flow cell. It will be appreciated that for example for stationary fluids it is also possible to provide other cells. A specimen to be analysed is introduced into that flow cell 9 by way of a pump 10 from a specimen vessel 11, the specimen passing into a waste container 12 after passing through the flow cell 9.

The beams reflected by the prism are received by a photodetector matrix 13. The corresponding signals are passed by way of a framegrabber interface 14 to the computer 15 for evaluation.

The wavelengths of the two laser beams from the diode lasers 1 and 2 are set to the oppositely disposed flanks of the resonance curve so that the reflection is preferably the same for both wavelengths.

For the purposes of determining the surface plasmon resonances at the two-dimensional measurement surface (gold layer 8), the individual reflected beams are not evaluated as such, but the difference in the reflected intensities.

A typical measurement result is shown in FIG. 2, more specifically in dependence on temperature. In that respect a reference signal is firstly to be seen, which is received continuously in the measurement procedure itself, insofar as at least a region of the entire measurement surface (gold layer 8) is used as a reference surface for continuous standardisation of the measurement procedure.

The actual measurement signal at any location is identified in FIG. 2 by Signal. The difference signal in respect of the reflected intensities, which in accordance with the invention is ascertained to characterise plasmon resonance, is identified by Difference.

1-4. (canceled)

5. A method of determining surface plasmon resonances at a two-dimensional measurement surface formed by a thin metal film, the method comprising the following steps:
bringing the measurement surface into contact with a specimen to be measured;
illuminating the measurement surface with two collimated monochromatic laser beams of differing wavelengths which are spatially combined to form an overall beam;
measuring a difference in intensities of the two beams at the two wavelengths, to characterize plasma resonance.

6. The method according to claim 5, wherein the wavelengths of the two laser beams are set to oppositely disposed flanks of a resonance curve, such that a reflection of both wavelengths is at least approximately equal.

7. The method according to claim 5, wherein the step of measuring is accomplished with a triggerable CCD camera or a matrix comprising a plurality of photoelectric diodes at a plurality of measurement points of the measurement surface.

8. The method according to claim 7, further comprising the step of standardizing the step of measuring using at least a portion of the measurement surface as a reference surface.
